(19) United States
(12) Patent Application Publication
(10) Pub. No.: US 2016/0055049 A1
(43) Pub. Date: Feb. 25, 2016

(54) ULTRA LOW POWER PROGRAMMABLE SUPERVISORY CIRCUIT

(71) Applicant: Analog Devices Global, Hamilton (BM)

(72) Inventor: Dzianis Lukashevich, Munich Bavaria (DE)

(21) Appl. No.: 14/465,986

(22) Filed: Aug. 22, 2014

(51) Int. Cl. G06F 11/07

(52) U.S. Cl. CPC G06F 11/0757; G06F 11/0706

(57) ABSTRACT

An ultra-low-power supervisory circuits can employ floating gate transistors. In an example, a supervisory circuit can include a reset output circuit, a voltage comparator circuit configured to reset the reset output circuit when a first input voltage falls below a reference voltage, and a watchdog circuit configured to receive a watchdog signal and to reset the reset output circuit if the watchdog signal does not transition within a predetermined watchdog interval. The voltage comparator circuit can include a first floating gate transistor circuit configured to establish a reference current for generating the reference voltage, and the watchdog circuit can include a second floating gate transistor circuit for selecting the predetermined watchdog interval.

### BACKGROUND

Supervisory circuits can provide an indication of a problem to a host system including the supervisory circuit. The indication can be used to initiate routines to provide a controlled response to the detected problem. For example, a supervisory circuit can include a voltage comparator for detecting when a supply voltage falls too low, and can include a watchdog timer circuit to detect when a processing component has failed to execute properly. Upon detection of such events, an output of the supervisory circuit can be reset to provide an indication of the event. The indication can be used, in certain cases, to perform housekeeping tasks and shut down the host system in an ordered process.

### OVERVIEW

This application discusses, among other things, ultra-low-power supervisory circuits employing floating gate transistors. In an example, a supervisory circuit can include a reset output circuit, a voltage comparator circuit configured to reset the reset output circuit when a first input voltage falls below a reference voltage, and a watchdog circuit configured to receive a watchdog signal and to reset the reset output circuit if the watchdog signal does not transition within a predetermined watchdog interval. The voltage comparator circuit can include a first floating gate transistor circuit configured to establish a reference current for generating the reference voltage, and the watchdog circuit can include a second floating gate transistor circuit for selecting the predetermined watchdog interval.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

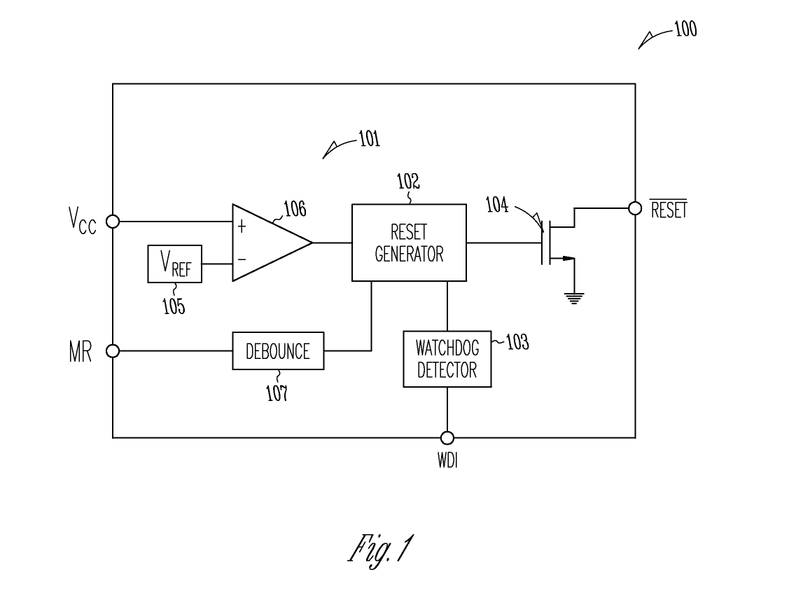

FIG. 1 illustrates generally an example of a supervisory circuit 100 that can include a voltage comparator circuit 101, a reset generator circuit 102, a watchdog detector circuit 103 and a reset output circuit 104. In certain examples, the supervisory circuit 100 can monitor the initial power-up of a supply voltage (V_{cc}), can hold the reset output circuit 104 of in a reset state while the supply voltage (V_{cc}) is below a power-on threshold, can provide a power-on delay after the supply voltage (V_{cc}) rises above the power-on threshold, and can transition the reset output circuit 104 to a non-reset state after completion of the power-on delay using the reset generator 102.

In some examples, the supervisory circuit 100 can monitor the supply voltage (V_{cc}) and can provide an indication when the supply voltage (Vcc) falls below a reference voltage (V_{REF}) such as using the voltage comparator circuit 101 and the reset generator 102. In some examples, the voltage comparator circuit 101 can include or be coupled to a reference generator 105 such as for providing the reference voltage (V_{REF}) and can include a comparator 106 such as for comparing the supply voltage (V_{cc}) to the reference voltage (V_{REF}). In certain examples, the indication provided by the supervisory circuit 100 can include a transition of the reset output circuit 104 of the supervisory circuit 100 to the reset state.

In certain examples, the supervisory circuit 100 can monitor a watchdog input (WDI) for transitions and can reset a timer or timing circuit of the watchdog detector 103 after a detected transition. If the watchdog interval of the timer or timing circuit lapses or expires before a detected transition at the watchdog input (WDI), an indication of a watchdog failure can be provided by the supervisory circuit 100. In certain examples, the indication of the watchdog failure can be in the form of a transition of the reset output circuit 104 of the supervisory circuit 100 to the reset state. In some examples, the reset generator circuit 102 can drive the reset output circuit 104 responsive to output signals received from the voltage comparator circuit 101 and the watchdog detector circuit 103. In some examples, a supervisory circuit 100 can include a manual reset input (MR) such as for manually causing a transition of the reset output circuit 104 and the reset generator 102 can be responsive to the state of the manual reset input (MR). In some examples, the supervisory circuit 100 can include a debounce circuit 107, such as for debouncing the manual reset input (MR), such as to limit nuisance resetting of the reset output circuit 104 of the supervisory circuit 100.

The present inventors have recognized, among other things, that floating gate technology can be included in the supervisory circuit 100, such as to provide the same or more flexible functionality of traditional supervisory circuits while reducing power consumption, ameliorating thermal sensitivity, providing reprogrammable delay intervals, providing a programmable reference voltage, or one or more combinations thereof.

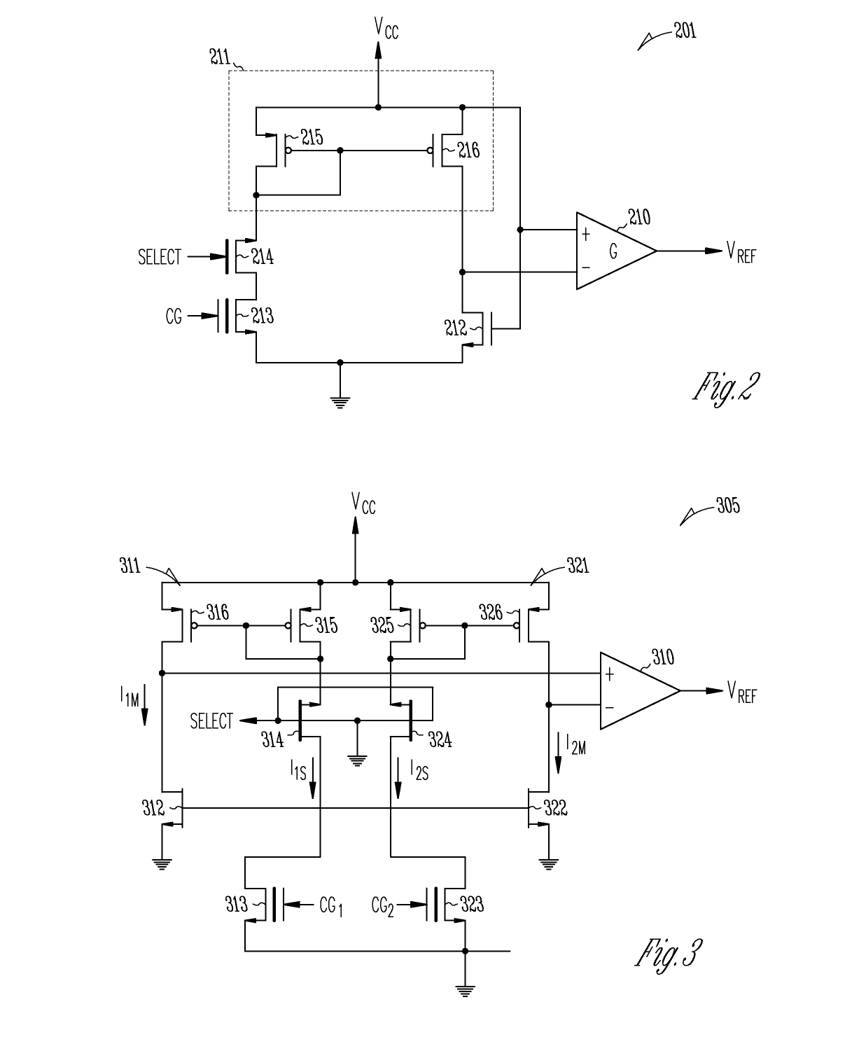

FIG. 2 illustrates generally an example of a reference generator 205 that can be included in the voltage comparator circuit 101. In certain examples, the reference generator 205 can include an amplifier 210, a current mirror 211, a load 212 and a floating gate transistor 213. In some examples, the amplifier 210 can provide the reference voltage (V_{REF}) at an output of the reference generator 205. In certain examples, the floating gate transistor 213 can provide a sense current for the current mirror 211. In some examples, the amplifier 210 can amplify a difference between a supply voltage (V_{cc}) and a load voltage generated by a mirrored current of the floating gate transistor 213 across the load 212, such as a load transistor. The floating gate transistor 213 can be programmed by storing or removing charge from the floating gate of the floating gate transistor 213, such as using the control gate (CG). The charge on the floating gate can determine the threshold voltage of the floating gate transistor 213 and the sense current of the current mirror 211. Thus, adjusting the charge on the floating gate of the floating gate transistor 213 can modulate the load voltage across the load 212 and thus, can allow the reference voltage (V_{REF}) provided by the reference generator 201 to be programmable.

The reference generator 205 can include a protection transistor 214. The protection transistor 214 can provide one or multiple advantages. For example, the protection transistor 214 can be used to enable or disable the reference generator 205 such as using a select input (SELECT). An enable and disable ability can allow the reference generator 205 to be disabled when not in use, thus, saving energy. This can extend the battery life of a battery-powered electronic device employing the supervisory circuit 100. In an example, the protection transistor 214 can electrically isolate the floating gate transistor 213 from the current mirror transistors 215, 216. This can be desirable when the floating gate transistor 213 is programmed or re-programmed because removing or placing charge on the floating gate can employ voltages that can exceed the voltage ratings of the current mirror transistors 215, 216. For example, the current mirror transistor 215, 216 can have voltage ratings of about 5 volts or less and the programing voltage of the floating gate transistor 213 can be much higher (e.g., such as, but not limited to, 12 volts or 20 volts, or voltages that are two times, three times, or four times higher than the voltage rating of the current mirror transistors 215, 216 or other transistors coupled to the supervisory circuit 100. The protection transistor 214 can include a high voltage transistor, which can have a voltage rating sufficient to withstand, for example, the programming voltages associated with programming the floating gate transistor 213.

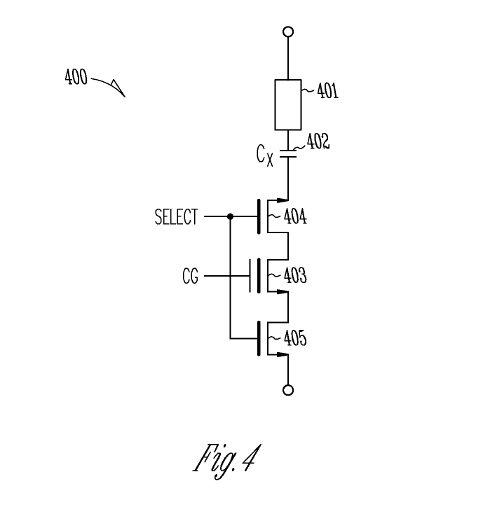

FIG. 3 illustrates an example reference generator of an example reference generator 305 that uses the differential charge of two floating gate transistors 313, 317 to provide the reference voltage. In certain examples, the charge on a floating gate of a floating gate transistor can change over time. Basing a voltage reference on the difference between charges on two floating gate transistors that are fabricated together can make the voltage reference more robust because the change in charge will be similar for each floating gate transistor. Thus, the difference in charge will remain constant over time, as well as, over numerous cycles of environmental changes. In an example, a differential charge based reference generator 305 can include an amplifier 310, a first current mirror circuit 311, and second mirror circuit 321. The first mirror circuit 311 can include a first sense transistor 315 and a first mirror transistor 316, a first load 312, and a first floating gate transistor 313. The second current mirror circuit can include a second sense transistor 325 and a second mirror transistor 326, a second load 322, and a second floating gate transistor 323. In the illustrated example, the first floating gate transistor 313 can be programed with a first floating gate charge that can determine a first sense current I₁ₛ. The second floating gate transistor 323 can be programed with a second floating gate charge that can determine a second sense current I₂ₛ. The floating gate transistors 313, 323 can be programmed by storing or removing charge from the floating gate using the control gate (CG₁, CG₂). The mirror current (I_{1M}, I_{2M}) of each current mirror 311, 321 can provide a first voltage (V₁) across the first load 312 and a second voltage (V₂) across the second load 322. The difference between the first voltage (V₁) and the second voltage (V₂) can be representative of the difference between the first floating gate charge and the second floating gate charge. The amplifier 310 can provide a representation of the difference between the first voltage (V₁) and the second voltage (V₂) and can be provided as the reference voltage (V_{REF}) at an output of the amplifier 310. As discussed above, in some examples, the example reference generator 305 can include protection transistors 314, 324 to isolate low voltage components from the floating gate transistors 313, 323. In some examples, the protection transistors 314, 324 can include a high voltage transistor having a voltage rating or breakdown voltage sufficient to withstand, for example, the programming voltages associated with programming the floating gate transistors 313, 324. In some examples, the protection transistors 314, 324 can be used to enable and disable use of the reference generator 305.

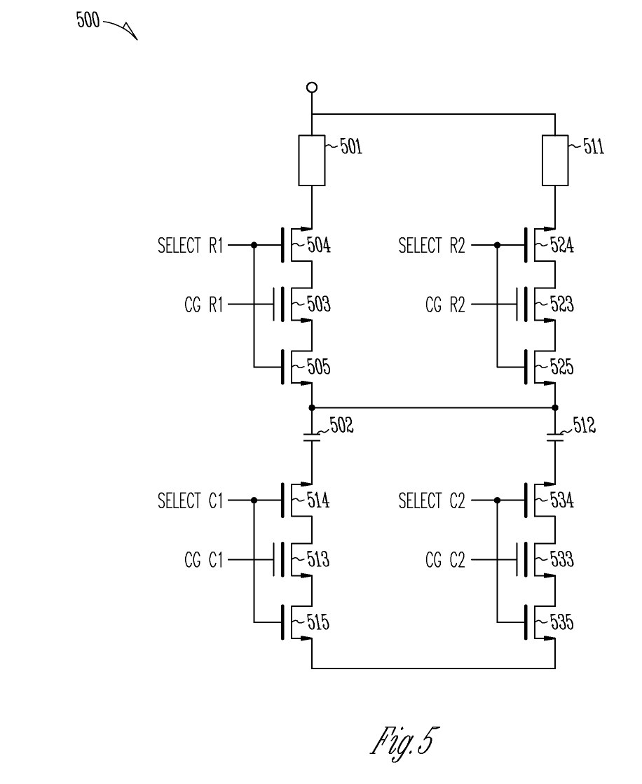

FIG. 4 illustrates generally an example of a programmable resistor-capacitor (RC) network 400 such as for an example of watchdog detector 103. The RC network 400 can include a resistive element, such as a resistor 401, a capacitive element, such as a capacitor 402, and a floating gate transistor 403. Charging or discharging the capacitor 402, such as via the resistor 401, can establish or provide a base timing interval for the watchdog detector 103 or for an initial power on delay of the supervisory circuit 100. The floating gate transistor 403 can be used to select or to fine tune the base timing interval, such as by placing charge onto or removing charge from the floating gate of the floating gate transistor 403. The RC network 400 can include one or more protection transistors 404, 405, such as for isolating the floating gate transistor 403 from one or more other circuit components such as when the floating gate transistor 403 is programmed or erased. A protection transistor 404, 405 can be used to select or de-select an RC network 400, such as to operate with one or more other components. For example, one or more RC networks 400 can be included in the watchdog detector or the reset generator, such as for providing the watchdog delay interval or the power-on delay. Protection transistors 404, 405 of the RC networks can be used to program the watchdog delay or the power-on delay such as to a specified or predetermined interval length, such as by selecting or deselecting certain RC networks to operate in the respective delay circuit. The protection transistors 404, 405 can include a high voltage transistor, which can have a voltage rating sufficient to withstand, for example, the programming voltages associated with programming the floating gate transistor 403. In some examples, the protection transistors 404, 405 can be an open gate transistor that can conduct when gate is ground or 0V as default and can be used for protection purpose during programming/erasing cycles (e.g., non-conducting when gate is high).

FIG. 5 illustrates generally an example of an RC network matrix 500 that can be used to provide a delay, such as the watchdog delay or the power-on delay, and can be programmed and re-programmed. The RC network matrix 500 can include a plurality of resistors 501, 511, capacitors 502, 512, floating gate transistors 503, 513, 523, 533, and, optionally, protection transistors 504, 514, 524, 534, 505, 515, 525, 535 that can be coupled in series, coupled in parallel, or coupled in series and in parallel. The protection transistors 504, 514, 524, 534, 505, 515, 525, 535 can include a high voltage transistor, such as having a voltage rating sufficient to withstand, for example, the programming voltages associated with programming the floating gate transistors 503, 513, 523, 533.

The floating gate transistors 503, 513, 523, 533 can allow selection of certain resistors or capacitors for operation as an RC network to provide a certain delay time. One or more of the protection transistors 504, 514, 524, 534, 505, 515, 525, 535 can allow selection of certain resistors or capacitors for operation as an RC network to provide a certain delay time. Charge on the floating gate of a floating gate transistor can affect the capacitance or the resistance of the RC network, thus, the floating gate transistors 503, 513, 523, 533 can be used to provide fine tuning of a RC network based delay interval. In some examples, the select transistors can affect the capacitance or the resistance of the RC network. The optional protection transistors 504, 514, 524, 534, 505, 515, 525, 535 can be used to program a coarse delay interval and the floating gate transistors 503, 513, 523, 533 can be used to refine the delay interval. The floating gate transistors 503, 513, 523, 533 can be programmed by modifying the charge stored on the floating gate. Other delay networks for supervisory circuits that are “programmable” may use fuses to select the delay interval and thus, are not re-programmable. In some examples, existing delay networks for supervisory circuits need external R and/or C components to set-up the delay times. Thus, the present subject matter can allow re-programmability as well as fine tuning of one or more delay intervals associated with the supervisory circuit such as the watchdog delay interval and the power-on delay interval. In certain examples, the reference voltage (V_{REF}) of an example supervisory circuit can be programmed/re-programmed to a needed value with a high accuracy using the same floating gate technology.

### VARIOUS NOTES & EXAMPLES

In Example 1, a supervisory circuit can include a reset output circuit, a voltage comparator circuit configured to reset the reset output circuit when a first input voltage falls below a reference voltage, a watchdog circuit configured to receive a watchdog signal and to reset the reset output circuit if the watchdog signal does not transition within a predetermined watchdog interval, wherein the voltage comparator circuit includes a first floating gate transistor circuit configured to establish a reference current for generating the reference voltage, and wherein the watchdog circuit includes a second floating gate transistor circuit for selecting the predetermined watchdog interval.

In Example 2, the voltage comparator of Example 1 optionally includes a reference voltage generator including the first floating gate transistor.

In Example 3, the reference voltage generator of any one or more of Examples 1-2 optionally includes a first current mirror, the first floating gate circuit configured to establish a sense current for the first current mirror.

In Example 4, the reference voltage generator of any one or more of Examples 1-3 optionally includes a protection transistor configured to electrically isolate the first current mirror from the floating gate circuit in a first state.

In Example 5, the protection transistor of any one or more of Examples 1-4 optionally is configured to electrically couple the current mirror with the floating gate circuit in a second state.

In Example 6, the protection transistor of any one or more of Examples 1-5 optionally includes a voltage rating than is higher than a voltage rating of the current mirror.

In Example 7, the supervisory circuit of any one or more of Examples 1-6 optionally includes a second floating gate transistor, wherein a magnitude of the reference voltage is responsive to a difference between a first charge stored on the first floating gate transistor and a second charge stored on the second floating gate transistor.

In Example 8, the second floating gate circuit of any one or more of Examples 1-7 optionally includes resistive circuit and a capacitor circuit for providing the predetermined watchdog interval, wherein the resistive circuit includes a second floating gate transistor, the second floating gate transistor programmable to select a resistance of the resistive circuit.

In Example 9, the second floating gate circuit of any one or more of Examples 1-8 optionally includes a plurality of resistive and capacitive devices, each resistive device including a second floating gate transistor coupled in series with a corresponding capacitive device.

In Example 10, each resistive device and corresponding capacitive device of any one or more of Examples 1-9 optionally include a selection transistor, the selection transistor configured to electrically enable the resistive device and the capacitive device to effect the watchdog interval in a first state, and to electrically isolate the resistive device and the capacitive device to effect the watchdog interval in a second state.

In Example 11, at least two resistive and capacitive devices of the plurality of resistive and capacitive devices of any one or more of Examples 1-10 optionally are coupled in series.

In Example 12, at least two resistive and capacitive devices of the plurality of resistive and capacitive devices of any one or more of Examples 1-11 optionally are coupled in parallel.

In Example 13, at least a first two resistive and capacitive devices of the plurality of resistive and capacitive devices of any one or more of Examples 1-12 optionally are coupled in series and a second two resistive and capacitive devices of the plurality of resistive and capacitive devices of any one or more of Examples 1-12 optionally are coupled in parallel to form a resistive-capacitive matrix.

In Example 14, a method can include generating a reference voltage for a power-on reset circuit of a supervisory circuit across a load using a first floating gate transistor, comparing the reference voltage to a supply voltage using a voltage comparator circuit, resetting an output of the power-on reset circuit after the supply voltage falls below the reference voltage using an output of the comparator circuit and a reset generator, delaying a watchdog interval, and resetting the output when the watchdog interval has elapse, wherein a second floating gate transistor is configured to set the watchdog interval.

In Example 15, the generating the reference voltage of any one or more of Examples 1-14 optionally includes providing a sense current of a current mirror using the first floating gate transistor, wherein the sense current is based on a first charge stored on the floating gate of the first floating gate transistor.

In Example 16, the generating the reference voltage of any one or more of Examples 1-2 optionally includes providing a second current using a second floating gate transistor, and the reference voltage is based on a difference between the first charge stored on the floating gate of the first floating gate transistor and a second charge stored on the floating gate of the second floating gate transistor.

In Example 17, the method of any one or more of Examples 1-2 optionally includes receiving an initial supply of the supply voltage at the comparator circuit, delaying a power-on reset interval after a voltage of the initial supply of the supply voltage is greater than the reference voltage, and setting the output of the power-on reset circuit upon completion of the power-on reset interval.

In Example 18, the delaying the power-on reset interval of any one or more of Examples 1-17 optionally includes charging an power-on resistor-capacitor (RC) network, the power-on RC network enabled using a selection floating gate transistor.

In Example 19, the method of any one or more of Examples 1-18 optionally includes resetting the watchdog interval upon reception of the reset signal at a watchdog input of the supervisory circuit.

In Example 20, the delaying the watchdog interval of any one or more of Examples 1-19 optionally includes charging or discharging a watchdog resistor-capacitor (RC) network wherein a resistance and a capacitance of the watchdog RC network is selected using the second floating gate transistor.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A supervisory circuit comprising;
a reset output circuit;
a voltage comparator circuit configured to reset the reset output circuit when a first input voltage falls below a reference voltage;
a watchdog circuit configured to receive a watchdog signal and to reset the reset output circuit if the watchdog signal does not transition within a predetermined watchdog interval;
wherein the voltage comparator circuit includes a first floating gate transistor circuit configured to establish a reference current for generating the reference voltage; and
wherein the watchdog circuit includes a second floating gate transistor circuit for selecting the predetermined watchdog interval.

2. The supervisory circuit of claim 1, wherein the voltage comparator includes a reference voltage generator including the first floating gate transistor.

3. The supervisory circuit of claim 2, wherein the reference voltage generator includes a first current mirror, the first floating gate circuit configured to establish a sense current for the first current mirror.

4. The supervisory circuit of claim 3, wherein the reference voltage generator includes a protection transistor configured to electrically isolate the first current mirror from the floating gate circuit in a first state.

5. The supervisory circuit of claim 4, wherein the protection transistor is configured to electrically couple the current mirror with the floating gate circuit in a second state.

6. The supervisory circuit of claim 4, wherein the protection transistor includes a voltage rating than is higher than a voltage rating of the current mirror.

7. The supervisory circuit of claim 3, including a second floating gate transistor, wherein a magnitude of the reference voltage is responsive to a difference between a first charge stored on the first floating gate transistor and a second charge stored on the second floating gate transistor.

8. The supervisory circuit of claim 1, wherein the second floating gate circuit includes resistive circuit and a capacitor circuit for providing the predetermined watchdog interval, wherein the resistive circuit includes a second floating gate transistor, the second floating gate transistor programmable to select a resistance of the resistive circuit.

9. The supervisory circuit of claim 1, wherein the second floating gate circuit includes a plurality of resistive and capacitive devices, each resistive device including a second floating gate transistor coupled in series with a corresponding capacitive device.

10. The supervisory circuit of claim 9, wherein each resistive device and corresponding capacitive device include a selection transistor, the selection transistor configured to electrically enable the resistive device and the capacitive device to effect the watchdog interval in a first state, and to electrically isolate the resistive device and the capacitive device to effect the watchdog interval in a second state.

11. The supervisory circuit of claim 9, wherein at least two resistive and capacitive devices of the plurality of resistive and capacitive devices are coupled in series.

12. The supervisory circuit of claim 9, wherein at least two resistive and capacitive devices of the plurality of resistive and capacitive devices are coupled in parallel.

13. The supervisory circuit of claim 9, wherein at least a first two resistive and capacitive devices of the plurality of resistive and capacitive devices are coupled in series and a second two resistive and capacitive devices of the plurality of resistive and capacitive devices are coupled in parallel to form a resistive-capacitive matrix.

14. A method comprising:
generating a reference voltage for a power-on reset circuit of a supervisory circuit across a load using a first floating gate transistor;
comparing the reference voltage to a supply voltage using a voltage comparator circuit;
resetting an output of the power-on reset circuit after the supply voltage falls below the reference voltage using an output of the comparator circuit and a reset generator;
delaying a watchdog interval; and
resetting the output when the watchdog interval has elapse, wherein a second floating gate transistor is configured to set the watchdog interval.

15. The method of claim 14, wherein the generating the reference voltage includes providing a sense current of a current mirror using the first floating gate transistor, wherein the sense current is based on a first charge stored on the floating gate of the first floating gate transistor.

16. The method of claim 14, wherein the generating the reference voltage includes providing a second current using a second floating gate transistor; and
wherein the reference voltage is based on a difference between the first charge stored on the floating gate of the first floating gate transistor and a second charge stored on the floating gate of the second floating gate transistor.

17. The method of claim 14, including receiving an initial supply of the supply voltage at the comparator circuit;
delaying a power-on reset interval after a voltage of the initial supply of the supply voltage is greater than the reference voltage; and
setting the output of the power-on reset circuit upon completion of the power-on reset interval.

18. The method of claim 17, wherein delaying the power-on reset interval includes charging an power-on resistor-capacitor (RC) network, the power-on RC network enabled using a selection floating gate transistor.

19. The method of claim 14, including resetting the watchdog interval upon reception of the reset signal at a watchdog input of the supervisory circuit.

20. The method of claim 14, wherein delaying the watchdog interval includes charging or discharging a watchdog resistor-capacitor (RC) network wherein a resistance and a capacitance of the watchdog RC network is selected using the second floating gate transistor.
